(19) United States
(12) Patent Application Publication
(10) Pub. No.: US 2018/0352900 A1
(43) Pub. Date: Dec. 13, 2018

(54) SHOE, IN PARTICULAR SPORTS SHOE

(71) Applicant: PUMA SE, Herzogenaurach (DE)

(72) Inventors: Matthias HARTMANN, Forchheim (DE); Romain GIRARD, Lauf an der Pegnitz (DE)

(73) Assignee: PUMA SE, Herzogenaurach (DE)

(21) Appl. No.: 15/781,389

(22) PCT Filed: Dec. 7, 2015
(86) PCT No.: PCT/EP2015/002456

§ 371 Date: Jun. 4, 2018

(51) Int. Cl. A43B 13/04; A43B 13/12; A43B 13/18; B29D 35/12

(52) U.S. Cl. CPC A43B 13/04; B29D 35/122; A43B 13/188; A43B 13/12

(57) ABSTRACT

A shoe, in particular to a sports shoe, having a sole and a shoe upper connected to the sole. In order to improve the cushioning properties of the shoe in a simply producible manner, at least one hollow space is formed in the sole, wherein the hollow space is filled with a number plastic bodies, wherein the plastic bodies are arranged in the hollow space without any connection to one another and wherein the hollow space is closed by a closure element.

The invention relates to a shoe, in particular to a sports shoe, having a sole and a shoe upper connected to the sole, wherein at least one hollow space is formed in the sole, wherein the hollow space is filled with a number plastic bodies, wherein the plastic bodies are arranged in the hollow space without any connection to one another, and wherein the hollow space is closed by means of a closure element.

A shoe of the generic kind is known from WO 2006/066256 A2. A similar solution shows WO 99/29203 A1 and US 2013/0145653 A1.

Another shoe is known from US 2009/0013558 A1. The shoe sole which is provided here consists of different plastic materials which are connected with another, wherein different polymer materials are used. Further solutions are disclosed in EP 2 649 896 A2, WO 2007/024523 A1 and WO 01/01806 A1.

In WO 2007/082838 A1 it is described that for a shoe sole also expanded thermoplastic polyurethane (E-TPU) can be beneficially used. In this document also detailed information concerning this plastic material are present; insofar explicit reference is made to this document.

A similar shoe discloses also DE 10 2011 108 744 B4 where in similar manner E-TPU for the sole is used. Here it is described that single foamed plastic spheres made from this material, which have mostly dimensions of a few millimetres, are formed to the sole according to a possible production method by supplying a binder in a respective tool so that the plastic spheres are connected with another and form the body of the sole. According to another method water steam is supplied into a tool under defined pressure in which the plastic spheres are inserted. Thereby, a partial melting of the plastic material takes place so that the plastic spheres are joined with another by adhesive bond and so form the body of the sole.

The properties of the shoe which can be obtained thereby, especially with respect to its damping behaviour, are not always fully satisfying. Furthermore the production method of the mentioned sole is sometimes relatively laborious and thus costly.

So, it is the object of the invention to further develop a shoe of the above mentioned kind so that its damping behaviour can be adjusted according to a desired manner effectively, wherein this should be possible in an easy manner so that the production costs of the shoe should remain low. Thus, the damping properties of the shoe should be improved with an easy method of production.

The solution of this object by the invention is characterized in that the plastic bodies are designed as spheres or ellipsoids which dimensions are between 1 mm and 13 mm in the three spatial directions, wherein the plastic bodies consist of expanded thermoplastic polyurethane (E-TPU), of expanded thermoplastic elastomere (E-TPE) and/or of expanded polypropylene (EPP).

The dimensions of the single plastic bodies are preferably between 3 mm and 9 mm in the three spatial directions.

Preferably the plastic bodies fill in at least largely, specifically preferred completely, the at least one hollow space.

The closure element can be formed by a foil or a plane textile material which is connected, preferably glued, with a part of the sole.

But it can further be provided that the closure element is formed by an insole, wherein the insole is preferably connected, preferably glued, with a part of the sole.

The plastic bodies consist preferably of foamed plastic material.

The sole which comprises the at least one hollow space consists preferably of thermoplastic polyurethane (TPU), of thermoplastic elastomere (E-TPE), of polyamide (PA) and/or of rubber material.

The sole can also comprise several hollow spaces.

According to a special embodiment of the invention it is provided that a first hollow space is filled with plastic bodies which have a first property and that a second hollow space is filled with plastic bodies which have a second property which is different to the first property. The property which can be chosen differently concerns thereby preferably the material of the plastic bodies, the size of the plastic bodies and/or the hardness of the plastic bodies.

The sole can comprise a midsole which has the at least one hollow space and which is connected with an outer sole.

Thereby it is possible that the sole or at least a part of the same is produced by an injection moulding process at which the at least one hollow space is formed.

The plastic bodies are preferably arranged in the at least one hollow space in full package under pressure. Thereby an at least substantial complete filling of the hollow space is ensured.

The plastic bodies have preferably a hardness of between 75 to 90 Shore A, preferably between 80 and 85 Shore A.

The plastic bodies have preferably a bulk density between 100 and 300 kg/m³.

Concerning the used expanded thermoplastic polyurethane (E-TPU) the following should be mentioned: As already mentioned above, this material is known as such and is for example used for shoes. It is for example available under the name “PearlFoam” from Huntsman International LLC or under the name “Infinergy” from BASF SE. With respect to this material explicitly reference is made to WO 2005/066250 A1 where detail of this details are found, thus of expanded thermoplastic polyurethanes and their production.

With respect to the pre-known thermoplastic elastomeres with urethane basis furthermore explicitly reference is made to WO 2010/010010 A1 in which an expandable thermoplastic polymer blend containing a blowing agent is disclosed which comprises thermoplastic polyurethane and styrene polymer. The polymer blend can thereby contain at least a further thermoplastic polymer. As further thermoplastic polymer can be taken in consideration especially polyamide (PA), polymethyl methacrylate (PMMA), polycarbonate (PC), polyethylene (PE), polypropylene (PP), polyvinylchloride (PVC), cellulose and polyoxymethylene (POM) respectively.

Thus, according to the invention expanded plastic foam spheres or ellipsoids are employed by use of especially E-TPU, E-TPE or EPP (for example to produce very light midsoles) which are filled in the created hollow space in the sole base body (said sole base body can also be called a pre-manufactured “cage” for the spheres and ellipsoids respectively).

The sole base body can be produced by injection moulding of by blow moulding (thereby the raw material is preferably TPU, PA or TPE) but also by a vulcanisation process (in the case of rubber) and contains at least one hollow space (recess) which is filled in with the mentioned spheres and ellipsoids respectively made of expanded plastic; said filling can take place without pressure but also under a certain pressure.

Subsequently, the hollow space is closed so that the spheres and ellipsoids respectively cannot fall out again. In the easiest case an insole is placed onto the opening of the hollow space and fixed. However, also a foil or a textile material can be provided by which the opening of the hollow space can be closed.

The sole which contains the at least one hollow space can thus function as side wall of a midsole. But it is also possible that this sole base body is used as outer sole.

Furthermore, the sole can comprise several, as the case may be different hollow spaces (chambers) to receive if applicable different qualities of spheres and ellipsoids respectively.

The spheres and ellipsoids respectively, preferably made of E-TPU, influence substantially the damping of the shoe so that the sole part with the filled hollow spaces is preferably used as midsole.

The sole can be connected with the shoe upper (shaft) by sewing of gluing which is known as such.

In the drawing an embodiment of the invention is shown.

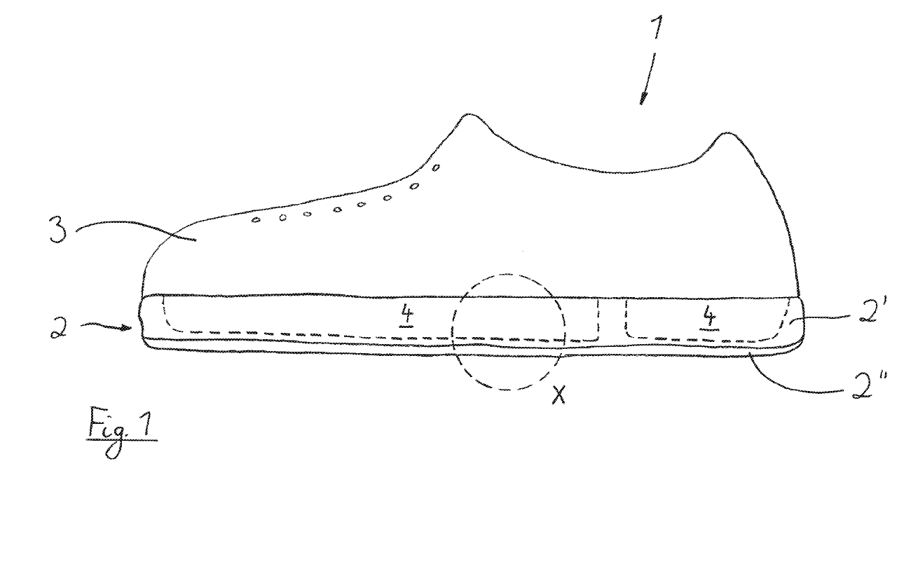

FIG. 1 shows the side view of a sports shoe and

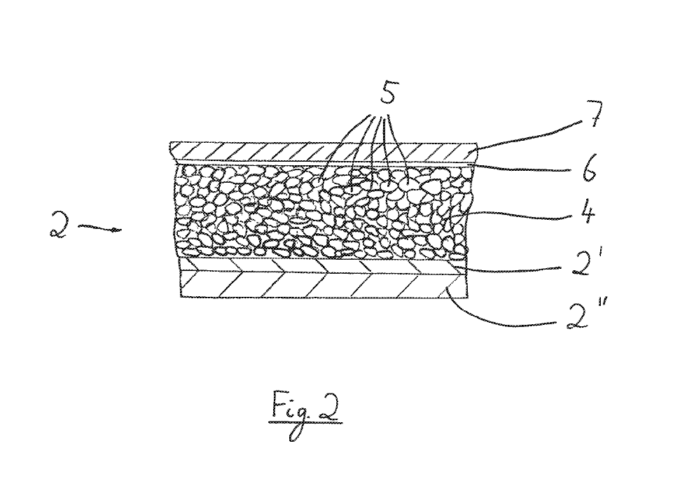

FIG. 2 shows a section through the sports shoe in enlarged depiction according to detail “X” of FIG. 1.

In FIG. 1 a shoe 1 can be seen which consists of a sole 2 and a shoe upper 3. The sole 2 can be firmly connected with the shoe upper 3 by sewing and/or by gluing. The sole 2 consists in the embodiment of in total three components, namely of a midsole 2′, at which bottom side an outer sole 2″ is arranged (for example glued). It can be seen from FIG. 2 that at the upper side of the midsole 2′ an insole 7 is arranged.

It is essential that in the sole 2—in the embodiment specifically in the midsole 2′—hollow spaces 4 are arranged as can be seen from FIG. 1. In the embodiment a larger hollow space 4 is provided in the forefoot and metatarsal region and a smaller hollow space 4 in the heel region. The hollow spaces 4 are recesses which are produced at the injection moulding of the midsole 2′. The hollow spaces 4 are limited downwards by the material of the midsole 2′; at the upper end of the midsole 2′ they are open.

Said openings are used to fill the hollow spaces 4 with plastic bodies 5 as can be seen from FIG. 2.

The plastic bodies 5 are spheres and ellipsoids respectively which consist of expanded thermoplastic polyurethane (E-TPU). Concerning this material hints to respective publications are already given above.

It is essential that the plastic bodies 5 are filled in the hollow space 4 quasi as bulk material and are arranged in the hollow space 4 loosely. Accordingly the plastic bodies 5 are free from any connection with another. After filling of the hollow space 4 the plastic bodies 5 support in fact against each other, but are loosely arranged to each other.

Hereby not only the damping behaviour of the sole and thus of the shoe can be influenced very beneficially; at the same time also the production process can be carried out easy and economically.

So that the plastic bodies 5 remain in the hollow space 4 during use of the shoe 1 the upper side of the midsole 2′, i.e. the access to the hollow spaces 4, is closed with a closure element 6.

In the embodiment according to FIG. 2 it can be seen that therefore a thin plastic foil is provided which can be glued at the upper side of the midsole 2′ to prevent the plastic bodies 5 from falling out of the hollow space 4. Then, in the embodiment the insole 7 is placed onto the plastic foil 6.

However, it can be also provided that the insole 7 itself functions as closure element 6 by fixing, especially gluing, it at the upper side of the midsole 2′ after filling of the hollow spaces 4 with plastic bodies 5.

The midsole 2′ can comprise transparent regions in its side region so that the plastic bodies 5 can be seen from the outside. The plastic bodies 5 can also be coloured to create a respective appearance of the sole and the shoe respectively.

### LIST OF REFERENCES

1 Shoe
2 Sole
2′ Midsole
2″ Outer sole
3 Shoe Upper
4 Hollow space
5 Plastic body
6 Closure element
7 Insole

1-13. (canceled)

14. A shoe, in particular sports shoe, having a sole and a shoe upper connected to the sole,
wherein at least one hollow space is formed in the sole,
wherein the hollow space is filled with a number plastic bodies, wherein the plastic bodies are arranged in the hollow space without any connection to one another, and
wherein the hollow space is closed by means of a closure element, wherein the plastic bodies are designed as spheres or ellipsoids which dimensions are between 1 mm and 13 mm in the three spatial directions, wherein the plastic bodies consist of expanded thermoplastic polyurethane (E-TPU), of expanded thermoplastic elastomere (E-TPE) and/or of expanded polypropylene (EPP).

15. The shoe according to claim 14, wherein the dimensions of the single plastic bodies are between 3 mm and 9 mm in the three spatial directions.

16. The shoe according to claim 14, wherein the plastic bodies fill in at least largely, preferably completely, the at least one hollow space.

17. The shoe according to claim 14, wherein the closure element is formed by a foil or a plane textile material which is connected, preferably glued, with a part of the sole.

18. The shoe according to claim 14, wherein the closure element is formed by an insole, wherein the insole is preferably connected, preferably glued, with a part of the sole.

19. The shoe according to claim 14, wherein the plastic bodies consist of foamed plastic material.

20. The shoe according to claim 14, wherein the sole which comprises the at least one hollow space consists of thermoplastic polyurethane, of thermoplastic elastomere, of polyamide and/or of rubber material.

21. The shoe according to claim 14, wherein the sole comprises several hollow spaces.

22. The shoe according to claim 21, wherein a first hollow space is filled with plastic bodies which have a first property and that a second hollow space is filled with plastic bodies which have a second property which is different to the first property.

23. The shoe according to claim 21, wherein the property is the material of the plastic bodies, the size of the plastic bodies and/or the hardness of the plastic bodies.

24. The shoe according to claim 14, wherein the sole comprises a midsole which has the at least one hollow space and which is connected with an outer sole.

25. The shoe according to claim 14, wherein the sole or at least a part of the same is produced by an injection molding process at which the at least one hollow space is formed.

26. The shoe according to claim 14, wherein the plastic bodies are arranged in the at least one hollow space in full package under pressure.
